(19) United States
(12) Patent Application Publication
(10) Pub. No.: US 2026/0277864 A1
(43) Pub. Date: Sep. 17, 2026

(54) Memory-Governed Admissibility System for Command and Control (C2) Behavior Constitution Based on Structured Memory Entity Participation

(71) Applicant: Xinxin Shan, Surrey (CA)

(72) Inventor: Xinxin Shan, Surrey (CA)

(73) Assignee: LED Smart Inc, Surrey (CA)

(21) Appl. No.: 19/667,527

(22) Filed: May 4, 2026

(51) Int. Cl. G06F 16/215; G06F 16/23

(52) U.S. Cl. CPC G06F 16/215; G06F 16/2365

(57) ABSTRACT

A system is provided in which system behavior corresponding to command and control (C2) functions exists through admissible structural participation of structured memory entities within a system memory domain. Representations corresponding to intelligence, surveillance, and reconnaissance (ISR) mechanisms, artificial intelligence components, and heterogeneous representation sources exist as candidate representations independent of system behavior. A transformation structure exists as a correspondence domain between candidate representations and structured memory entities, and a validation structure exists as an admissibility domain based on stored structural relationships, validated memory states, and structural consistency. Structured memory entities exist as admissible participation units only upon correspondence to admissibility conditions. System behavior exists only as a structural condition corresponding to admissible participation, and representations and candidate representations remain structurally non-constitutive of system behavior irrespective of source, confidence, or inferred relevance absent admissibility correspondence.

### CROSS-REFERENCE TO RELATED APPLICATIONS

This application is related to applications within the same patent family directed to memory-prioritized system architectures, admissibility-based structural systems, representation correspondence structures, identity continuity structures, bearer abstraction systems, and governance-conditioned participation architectures. Said related applications describe complementary structural aspects corresponding to system memory domains, admissibility conditions, structured memory entities, and representation normalization and validation structures, the disclosures of which are incorporated herein by reference.

### PRIOR ART

The references listed below are provided for verification and examination support purposes and correspond to publicly accessible patent documents.

The references listed herein are obtained from publicly accessible patent databases including the United States Patent and Trademark Office (USPTO) and Google Patents.

The inclusion of any reference herein is not an admission that such reference is material to patentability, is relevant to the claimed subject matter, or constitutes prior art against the present disclosure.

None of the listed references is known to disclose or suggest a system in which system behavior is constituted solely through admissible structural participation within a system memory domain.

US PATENT DOCUMENTS

| | |
|---|---|
| U.S. Pat. No. 8,249,042 B2 | August 2012 Sparr et al. |
| US 2005/0201340 A1 | September 2005 Wang et al. |
| U.S. Pat. No. 7,336,642 B2 | February 2008 Rich et al. |
| U.S. Pat. No. 11,265,799 B2 | March 2022 Tao et al. |
| U.S. Pat. No. 8,532,023 B2 | September 2013 Buddhikot et al. |
| U.S. Pat. No. 8,233,905 B2 | July 2012 Vaswani et al. |
| U.S. Pat. No. 10,383,069 B2 | August 2019 Nguyen-Dang |
| U.S. Pat. No. 10,728,751 B2 | July 2020 Lahteenmaki et al. |
| U.S. Pat. No. 10,007,513 B2 | June 2018 Malladi et al. |
| U.S. Pat. No. 9,882,833 B2 | January 2018 Mcbride et al. |
| U.S. Pat. No. 10,705,808 B2 | July 2020 Chiosi et al. |
| U.S. Pat. No. 11,348,597 B2 | May 2022 Hill et al. |
| U.S. Pat. No. 10,305,803 B2 | May 2019 Fredette et al. |
| U.S. Pat. No. 8,812,794 B2 | August 2014 Aronovich et al. |
| U.S. Pat. No. 8,255,605 B2 | August 2012 Rankin et al. |
| U.S. Pat. No. 11,082,525 B2 | August 2021 Sethuraman et al. |
| U.S. Pat. No. 9,450,817 B1 | September 2016 Bahadur et al. |

### BACKGROUND OF THE INVENTION

Existing command and control (C2) and intelligence, surveillance, and reconnaissance (ISR) systems are structured as transformation-based or inference-based processing architectures in which representations are permitted to directly influence or constitute system behavior. Such architectures rely on processing pipelines, statistical inference, or artificial intelligence-based models that allow representations originating from heterogeneous sources to participate in behavioral determination without structural correspondence to system-level constraints.

In particular, existing systems lack a structural mechanism by which representations corresponding to sensing systems, communication mechanisms, and artificial intelligence components are constrained from constituting system behavior absent correspondence to stored structural relationships and validated memory states. As a result, such systems may produce behavior structurally inconsistent with previously validated system states or governing structural constraints.

Accordingly, there exists a need for a system architecture in which system behavior is not derived from transformation, inference, or decision processes, but exists only upon structural correspondence with admissibility conditions existing within a governing system memory domain.

### SUMMARY OF THE INVENTION

The present disclosure provides a system in which system behavior corresponding to command and control (C2) functions exists through admissible structural participation of structured memory entities within a system memory domain.

A system memory domain exists as a domain in which admissibility conditions corresponding to allowable fact expressions, relational states, and structural participation forms exist. Representations corresponding to intelligence, surveillance, and reconnaissance (ISR) mechanisms, artificial intelligence components, and heterogeneous representation sources exist as candidate representations independent of system behavior.

A transformation structure exists as a correspondence domain between candidate representations and structured memory entities, and a validation structure exists as an admissibility domain based on stored structural relationships, validated memory states, and structural consistency. Structured memory entities exist as admissible participation units only upon correspondence to said admissibility conditions.

Said transformation structure and validation structure do not constitute processing, inference, or decision mechanisms, but exist as structural domains corresponding to correspondence and admissibility conditions independent of behavioral determination. System behavior exists only as a structural condition corresponding to admissible participation of structured memory entities, and representations do not constitute system behavior absent admissibility correspondence.

### BRIEF DESCRIPTION OF DRAWINGS

FIG. 1—Core Constitutional Structural Domain

FIG. 2—Representation-Memory Correspondence Structure

FIG. 3—Admissibility Correspondence Structure

FIG. 4—Behavioral Constitution Through Admissible Participation

FIG. 5—Artificial Intelligence Structural Participation

FIG. 6—Multi-Source ISR Structural Participation

### DETAILED DESCRIPTION OF THE INVENTION

The following figures define constitutional structural relationships corresponding to a memory-governed system in which system behavior exists only upon admissible structural participation of structured memory entities within a system memory domain. All illustrated elements represent structural existence, admissibility conditioning, representation correspondence, memory participation, and behavioral constitution relationships. No illustrated element represents execution sequence, procedural steps, transformation processes, routing, optimization, artificial intelligence decision-making, or control determination. All illustrated elements constitute a non-separable unified system.

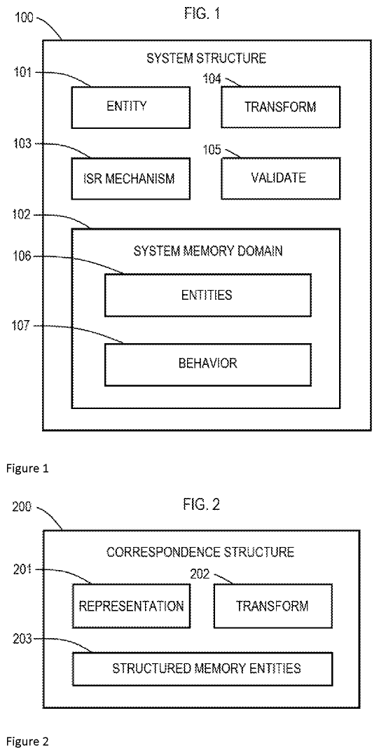

### FIG. 1—Core Constitutional Structural Domain

A system structure 100 constitutes a unified structural domain within which at least one entity 101 exists, wherein a system memory domain 102 exists as a governing structural domain in which admissibility conditions corresponding to allowable fact expressions, relational states, and structural participation forms are established, wherein at least one intelligence, surveillance, and reconnaissance (ISR) mechanism 103 exists as a representation-associated structural entity corresponding to candidate representations, wherein a transformation structure 104 exists as a correspondence structural domain between candidate representations and structured memory entities, wherein a validation structure 105 exists as an admissibility structural domain defined by admissibility correspondence conditions based on stored structural relationships and validated memory states, wherein structured memory entities 106 exist as admissible participation units within said system memory domain, and wherein system behavior corresponding to command and control functions 107 exists only as a structural condition corresponding to admissible participation of said structured memory entities.

### FIG. 2—Representation-Memory Correspondence Structure

A correspondence structure 200 constitutes a structural domain within which candidate representations 201 exist as governed fact expressions corresponding to at least one representation-associated structural entity, wherein a transformation structure 202 exists as a correspondence domain between said candidate representations and structured memory entities 203, wherein said structured memory entities exist as normalized representation forms corresponding to minimal validated operational structures, and wherein said correspondence domain exists independently of admissibility correspondence and independently of behavioral constitution.

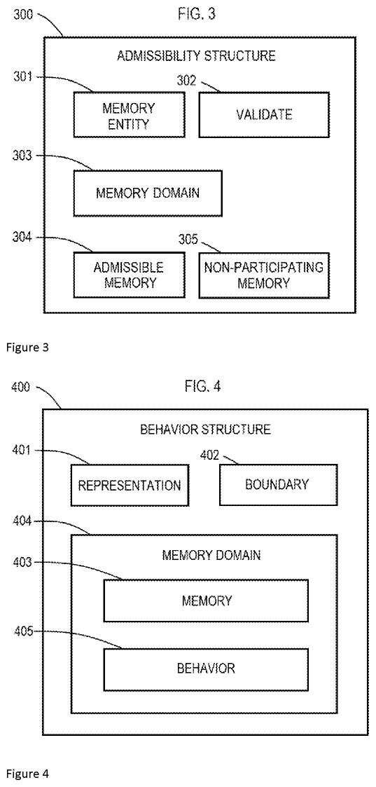

### FIG. 3—Admissibility Correspondence Structure

An admissibility structure 300 constitutes a structural domain within which a plurality of structured memory entities 301 exists, wherein a validation structure 302 exists as an admissibility correspondence domain, wherein a system memory domain 303 exists as a governing structural domain defining admissibility conditions corresponding to stored structural relationships and validated memory states, wherein structured memory entities 304 corresponding to said admissibility conditions exist as admissible participation units within said system memory domain, and wherein structured memory entities 305 exist as non-participating structures within the admissibility structure relative to system behavior.

### FIG. 4—Behavioral Constitution Through Admissible Participation

A behavioral constitution structure 400 constitutes a structural domain within which representations 401 exist as governed fact expressions, wherein a representation boundary 402 exists as a structural boundary separating representation existence from admissible participation, wherein structured memory entities 403 exist within and are contained by a system memory domain 404 as admissible participation units, and wherein system behavior corresponding to command and control functions 405 exists only as a structural condition corresponding to admissible participation of said structured memory entities.

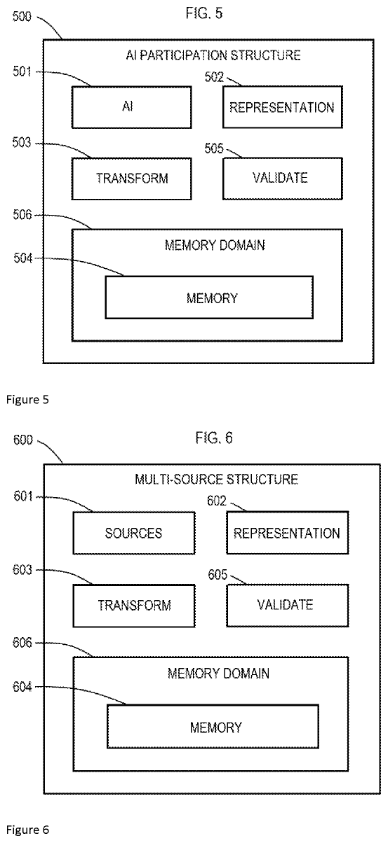

### FIG. 5—Artificial Intelligence Structural Participation

An artificial intelligence participation structure 500 constitutes a structural domain within which at least one artificial intelligence component 501 exists as a representation-associated structural entity, wherein candidate representations 502 exist as governed fact expressions corresponding to said artificial intelligence component, wherein a transformation structure 503 exists as a correspondence domain between said candidate representations and structured memory entities 504, wherein a validation structure 505 exists as an admissibility domain, wherein a system memory domain 506 exists as a governing structural domain, wherein structured memory entities corresponding to said candidate representations exist as admissible participation units only upon correspondence to admissibility conditions, and wherein said artificial intelligence component does not define system behavior and does not determine command authority or control authority.

### FIG. 6—Multi-Source ISR Structural Participation

A multi-source participation structure 600 constitutes a structural domain within which a plurality of heterogeneous representation sources 601 exists, wherein candidate representations 602 exist corresponding to said plurality, wherein a transformation structure 603 exists as a correspondence domain between said candidate representations and structured memory entities 604, wherein a validation structure 605 exists as an admissibility domain, wherein a system memory domain 606 exists as a governing structural domain, wherein structured memory entities corresponding to said candidate representations exist as admissible participation units only upon correspondence to admissibility conditions, and wherein system behavior within the system memory domain corresponding to said structured memory entities exists only upon admissible structural participation.

The following description defines constitutional structural relationships corresponding to a memory-governed system in which system behavior exists only upon admissible structural participation of structured memory entities within a system memory domain. All described elements represent structural existence, admissibility conditioning, representation correspondence, memory participation, and behavioral constitution relationships. No described element represents execution sequence, procedural steps, transformation processes, routing, optimization, artificial intelligence decision-making, or control determination. All described elements constitute a non-separable unified system. All described structures exist as coexisting structural domains without implying sequential transformation, processing, or causal progression between representation existence, memory correspondence, admissibility correspondence, and behavioral constitution.

A system comprises at least one entity existing within a unified structural domain. A system memory domain exists as a governing structural domain in which admissibility conditions corresponding to allowable fact expressions, relational states, and structural participation forms are established. Said admissibility conditions exist as stored structural relationships and validated memory states capable of defining admissible participation. Structured memory entities exist as governed fact expressions capable of participation within the system memory domain. System behavior corresponding to command and control (C2) functions exists as a structural condition defined by admissible participation of said structured memory entities. No representation or candidate representation exists as system behavior unless admitted through admissible structural participation. A structural boundary exists between representation existence and behavioral constitution, wherein representations corresponding to any source exist as non-constitutive structures absent admissibility correspondence.

Within the same system memory domain defined with respect to FIG. 1, at least one intelligence, surveillance, and reconnaissance (ISR) mechanism exists as a representation-providing structural entity corresponding to candidate representations. Said candidate representations exist as governed fact expressions independent of admissible participation. A transformation structure exists as a correspondence domain between candidate representations and structured memory entities. Said correspondence defines representation compatibility with admissibility conditions without implying admissible participation. Structured memory entities corresponding to said candidate representations exist as normalized forms corresponding to minimal validated operational structures, said normalized forms existing independently of admissibility correspondence.

Within the same system memory domain defined with respect to FIG. 1, a validation structure exists as an admissibility domain in which structured memory entities exist under admissibility correspondence conditions. Said admissibility correspondence is defined by structural consistency among representations, temporal alignment tolerance, spatial coherence, compatibility with stored structural relationships, consistency with validated memory states, and correspondence with admissibility constraints. Structured memory entities corresponding to said admissibility conditions exist as admissible participation units within the system memory domain. Structured memory entities not corresponding to said admissibility conditions exist as non-participating structures relative to system behavior and do not exist as system behavior.

Within the same system memory domain defined with respect to FIG. 1, system behavior corresponding to command and control (C2) functions exists as a structural condition defined by admissible participation of structured memory entities. Said structural condition exists independent of procedural command determination or control logic execution. Representations and candidate representations exist as non-constitutive structures relative to system behavior absent admissibility correspondence. Said structural boundary defines that representation existence and behavioral constitution are separated by admissibility correspondence.

Within the same system memory domain defined with respect to FIG. 1, at least one artificial intelligence component exists as a representation-generating structural entity corresponding to candidate representations for provision to the system. Said candidate representations exist as governed fact expressions independent of admissibility correspondence. A transformation structure exists as a correspondence domain between said candidate representations and structured memory entities. A validation structure exists as an admissibility domain in which said structured memory entities exist under admissibility correspondence conditions. Artificial intelligence components do not define system behavior and do not determine command authority or control authority. Structured memory entities corresponding to candidate representations generated by artificial intelligence components exist as admissible participation units only as defined by admissibility correspondence conditions. Said candidate representations exist as non-constitutive structures relative to system behavior irrespective of confidence, probability, or inferred relevance absent admissibility correspondence.

Within the same system memory domain defined with respect to FIG. 1, a plurality of heterogeneous representation sources exists, including sensing systems, surveillance systems, reconnaissance platforms, communication mechanisms, and externally generated intelligence sources. Said plurality corresponds to candidate representations associated with the system. A transformation structure exists as a correspondence domain between said candidate representations and structured memory entities. A validation structure exists as an admissibility domain in which said structured memory entities exist under admissibility correspondence conditions. Candidate representations corresponding to said plurality of heterogeneous representation sources exist as non-constitutive structures relative to system behavior absent admissibility correspondence. Structured memory entities corresponding to said candidate representations exist as admissible participation units only as defined by admissibility conditions. Said plurality participates as independent representation providers without defining system topology, admissibility conditions, command authority, control authority, or system behavior.

### Case 1—Multi-Modal Inconsistent Representation Field

A plurality of heterogeneous representation sources corresponds to candidate representations describing a common system-relevant condition, wherein said candidate representations exhibit structural inconsistency across modalities. Structured memory entities corresponding to said candidate representations exist within a correspondence domain independent of admissibility. Said structured memory entities exist as admissible participation units only as defined by admissibility correspondence conditions requiring structural consistency with stored structural relationships and validated memory states. Structured memory entities corresponding to said inconsistent candidate representations exist as non-participating structures and do not exist as system behavior.

### Case 2—Partial Correspondence Under Incomplete Conditions

Candidate representations correspond to incomplete system-relevant conditions in which subsets of representation attributes exist while other attributes remain absent. Structured memory entities corresponding to said candidate representations exist as partial structural representations within a correspondence domain. Said structured memory entities exist as admissible participation units only as defined by admissibility correspondence conditions requiring compatibility with stored structural relationships and validated memory states. Said partial representations exist as non-constitutive structures relative to system behavior absent admissibility correspondence.

### Case 3—Temporal Misalignment

Candidate representations correspond to system-relevant conditions associated with differing temporal states. Structured memory entities corresponding to said candidate representations exist within a correspondence domain independent of admissibility. Said structured memory entities exist as admissible participation units only as defined by admissibility correspondence conditions requiring temporal alignment tolerance relative to validated memory states. Structured memory entities not satisfying said correspondence exist as non-participating structures.

### Case 4—Spatial Divergence

Candidate representations correspond to spatially distributed conditions exhibiting geometric inconsistency. Structured memory entities corresponding to said candidate representations exist as spatially indexed governed fact expressions. Said structured memory entities exist as admissible participation units only as defined by admissibility correspondence conditions requiring spatial coherence within the system memory domain. Non-coherent structures exist as non-participating structures.

### Case 5—AI Hypothetical Representations

An artificial intelligence component corresponds to candidate representations describing hypothetical system-relevant conditions. Structured memory entities corresponding to said candidate representations exist within a correspondence domain. Said structured memory entities exist as admissible participation units only as defined by admissibility correspondence conditions requiring compatibility with stored structural relationships and validated memory states. Said candidate representations exist as non-constitutive structures relative to system behavior irrespective of confidence, probability, or inferred relevance.

### Case 6—Partial Consensus Under Conflict

A plurality of heterogeneous representation sources corresponds to candidate representations wherein subsets exhibit structural consistency while other subsets exhibit structural inconsistency. Structured memory entities corresponding to consistent subsets exist as admissible participation units as defined by admissibility correspondence conditions. Structured memory entities corresponding to inconsistent subsets exist as non-participating structures. System behavior exists only as a structural condition corresponding to admissible participation of said consistent structures.

### Case 7—Unknown Provenance Intelligence

Externally generated intelligence sources correspond to candidate representations lacking defined provenance. Structured memory entities corresponding to said candidate representations exist within a correspondence domain. Said structured memory entities exist as admissible participation units only as defined by admissibility correspondence conditions requiring compatibility with stored structural relationships and validated memory states. Said external representations exist as non-constitutive structures relative to system behavior absent admissibility correspondence.

### Case 8—High-Confidence Non-Correspondence

Candidate representations correspond to high-confidence system-relevant conditions yet exhibit structural incompatibility with stored structural relationships. Structured memory entities corresponding to said candidate representations exist within a correspondence domain. Said structured memory entities exist as non-participating structures and do not exist as system behavior irrespective of confidence level.

### Case 9—Multi-Domain Collision

A plurality of heterogeneous representation sources corresponds to candidate representations derived from radio-frequency, visual, and sensor domains. Structured memory entities corresponding to said candidate representations exist within a correspondence domain. Said structured memory entities exist as admissible participation units only as defined by admissibility correspondence conditions requiring cross-domain structural consistency. Inconsistent structures exist as non-participating structures.

### Case 10—Memory State Conflict

Candidate representations correspond to conditions conflicting with validated memory states. Structured memory entities corresponding to said candidate representations exist within a correspondence domain. Said structured memory entities exist as admissible participation units only as defined by admissibility correspondence conditions requiring compatibility with validated memory states. Conflicting structures exist as non-participating structures.

### Case 11—Multi-Hypothesis Coexistence

A plurality of candidate representations corresponds to alternative hypotheses describing system conditions. Structured memory entities corresponding to said candidate representations exist as parallel governed fact expressions. Said structured memory entities exist as admissible participation units only as defined by admissibility correspondence conditions requiring compatibility with admissibility constraints. Non-corresponding hypotheses exist as non-participating structures.

### Case 12—Signal Degradation

Candidate representations correspond to degraded signal conditions with dominant noise components. Structured memory entities corresponding to said candidate representations exist within a correspondence domain. Said structured memory entities exist as admissible participation units only as defined by admissibility correspondence conditions requiring compatibility with stored structural relationships and validated memory states. Noise-dominated structures exist as non-participating structures.

1. A system comprising at least one entity, wherein system behavior corresponding to command and control (C2) functions within the system is constituted through admissible structural participation of structured memory entities rather than through procedural determination, the system comprising:
a system memory domain stored within the at least one memory of the system in which admissibility conditions corresponding to allowable fact expressions, relational states, and structural participation forms are established;
at least one intelligence, surveillance, and reconnaissance (ISR) mechanism configured to provide candidate representations to the system;
a transformation structure implemented within the system comprising at least one of software, hardware, or logical processing components configured to convert the candidate representations into structured memory entities including minimal validated operational structures;
a validation structure implemented within the system configured to evaluate the structured memory entities for admissibility correspondence based on stored structural relationships within the system memory domain, validated memory states, and structural consistency across representations;
wherein the structured memory entities are incorporated into the system memory domain only upon correspondence to the admissibility conditions;
and wherein system behavior corresponding to C2 functions exists only upon admissible structural participation of the structured memory entities;
wherein the system operates as a direct system establishing structural conditions for participation of ISR-derived representations in C2-corresponding system behavior rather than as an auxiliary or support system;
wherein the system does not implement ISR or C2 as functional modules but governs structural conditions under which representations and behaviors corresponding thereto may exist;
and wherein no representation or candidate representation constitutes system behavior unless admitted through the admissible structural participation of the structured memory entities within the system memory domain associated with the at least one entity.

2. The system of claim 1, wherein the transformation structure is configured to normalize representations originating from the at least one ISR mechanism into structured memory entities corresponding to minimal validated operational structures.

3. The system of claim 1, wherein said validation structure evaluates structural consistency among structured memory entities corresponding to multiple ISR mechanisms.

4. The system of claim 1, wherein said validation structure evaluates temporal alignment tolerance among structured memory entities corresponding to independent representation sources.

5. The system of claim 1, wherein said validation structure evaluates spatial coherence corresponding to location-based representations.

6. The system of claim 1, wherein said validation structure evaluates compatibility of structured memory entities with stored structural relationships within the system memory domain.

7. The system of claim 1, wherein said validation structure evaluates consistency of structured memory entities with validated memory states.

8. The system of claim 1, wherein said validation structure evaluates correspondence of structured memory entities to system-level admissibility constraints.

9. The system of claim 1, wherein representations corresponding to inconsistent or non-corresponding structured memory entities are excluded from participation within the system memory domain.

10. The system of claim 1, wherein the system memory domain comprises stored structural relationships defining admissibility conditions.

11. The system of claim 1, wherein the system memory domain comprises validated memory states corresponding to previously admitted structured memory entities.

12. The system of claim 1, wherein system behavior corresponding to C2 functions is constituted independent of procedural command determination or control logic execution.

13. A system comprising at least one entity, wherein system behavior corresponding to command and control (C2) functions within the system is constituted through admissible structural participation of structured memory entities, the system comprising:
a system memory domain stored within the at least one memory of the system in which admissibility conditions corresponding to allowable fact expressions, relational states, and structural participation forms are established;
at least one artificial intelligence component configured to generate candidate representations for provision to the system;
a transformation structure implemented within the system configured to convert the candidate representations into structured memory entities;
and a validation structure implemented within the system configured to evaluate the structured memory entities for admissibility correspondence based on stored structural relationships within the system memory domain, validated memory states, and structural consistency;
wherein the at least one artificial intelligence component does not define system behavior and does not determine command authority or control authority;
and wherein outputs of the at least one artificial intelligence component are incorporated into the system memory domain only upon correspondence to the admissibility conditions;
wherein the system does not implement ISR or C2 as functional modules but governs structural conditions under which representations and behaviors corresponding thereto may exist;
and wherein no representation or candidate representation constitutes system behavior unless admitted through the admissible structural participation of the structured memory entities within the system memory domain associated with the at least one entity.

14. The system of claim 13, wherein outputs generated by the at least one artificial intelligence component are treated as candidate representations requiring admissibility correspondence prior to participation.

15. The system of claim 13, wherein no artificial intelligence component independently defines system behavior or command authority.

16. The system of claim 13, wherein the structured memory entities are evaluated based on stored structural relationships within the system memory domain and validated memory states.

17. A system comprising at least one entity, wherein system behavior corresponding to command and control (C2) functions within the system is constituted through admissible structural participation of structured memory entities, the system comprising:
a system memory domain stored within the at least one memory of the system in which admissibility conditions corresponding to allowable fact expressions, relational states, and structural participation forms are established;
a plurality of heterogeneous representation sources including at least one of sensing systems, surveillance systems, reconnaissance platforms, communication mechanisms, or externally generated intelligence sources configured to provide candidate representations to the system;
a transformation structure implemented within the system configured to convert the candidate representations from the plurality of heterogeneous representation sources into structured memory entities;
and a validation structure implemented within the system configured to evaluate the structured memory entities for admissibility correspondence based on stored structural relationships within the system memory domain, validated memory states, and structural consistency;
wherein candidate representations originating from the plurality of heterogeneous representation sources do not constitute system behavior prior to admissibility correspondence;
and wherein the structured memory entities are incorporated into the system memory domain only upon correspondence to the admissibility conditions;
wherein the system does not implement ISR or C2 as functional modules but governs structural conditions under which representations and behaviors corresponding thereto may exist;
and wherein no representation or candidate representation constitutes system behavior unless admitted through the admissible structural participation of the structured memory entities within the system memory domain associated with the at least one entity.

18. The system of claim 17, wherein said plurality of heterogeneous representation sources participate as independent providers without defining system topology or system behavior.

19. The system of claim 17, wherein the structured memory entities represent governed fact expressions capable of participation within the system memory domain.

20. The system of claim 17, wherein the system establishes a structural boundary between representation generation and behavioral constitution such that representations generated by said plurality of heterogeneous representation sources do not directly define system behavior.
